(19) United States
(12) Patent Application Publication
(10) Pub. No.: US 2026/0014897 A1
(43) Pub. Date: Jan. 15, 2026

(54) WARNING SYSTEM FOR PROVIDING A WARNING INDICATING A THERMAL RUNAWAY

(71) Applicant: Volvo Truck Corporation, GÖTEBORG (SE)

(72) Inventor: Gabriel TRÖNNBERG, TROLLHÄTTAN (SE)

(21) Appl. No.: 19/257,575

(22) Filed: Jul. 2, 2025

(30) Foreign Application Priority Data
Jul. 9, 2024 (EP) 24187268.8

(51) Int. Cl. B60L 58/10; B60L 1/00; B60L 50/60; B60L 50/64; H01M 10/42

(52) U.S. Cl. CPC B60L 58/10; B60L 1/00; B60L 50/64; B60L 50/66; H01M 10/4285; B60L 2240/10; B60L 2240/54; H01M 2220/20

(57) ABSTRACT

A warning system for providing a warning indicating a thermal runaway of a battery device, the warning system comprising an electromechanical switch configured to be operatively connected to a pressure actuatable device of the battery device such that actuation of the pressure actuatable device causes activation of the electromechanical switch, and an electric conduit connected to the electromechanical switch and configured to be connected to an indicating device for providing an indication of thermal runaway of the battery device.

### CROSS REFERENCE TO RELATED APPLICATIONS

This application claims priority to European Patent Application No. 24187268.8, filed on Jul. 9, 2024, the disclosure and content of which is incorporated by reference herein in its entirety.

### TECHNICAL FIELD

The disclosure relates generally to safety arrangements for power sources. In particular aspects, the disclosure relates to a warning system for providing a warning indicating a thermal runaway. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

The number of electrical vehicles powered by batteries is constantly increasing. This has pushed the development of battery technology and energy density of batteries has increased significantly in the past years. With the increased energy density, there is an increased risk of the battery experiencing thermal runaway.

Thermal runaway in batteries is a phenomenon in which a temperature of a battery increases rapidly and uncontrollably. This leads to a cascade of reactions that may result in a fire or an explosion. Thermal runaway may occur in any type of battery, but is more common in lithium-ion batteries due to their high energy density.

The thermal runaway process may be initiated by an external factor such as overcharging, short-circuiting, physical damage to the battery, or exposure to high temperatures. Once initiated, the thermal runaway can quickly become self-sustaining as the heat generated by the chemical reactions within the battery further increases the temperature, leading to a rapid increase in the rate of these reactions.

The consequences of thermal runaway may be severe. Thermal runaway may lead to the release of toxic gases, fire, and/or explosion, depending on the type and size of the battery. To prevent thermal runaway, battery manufacturers employ various safety measures, including using materials that are less prone to thermal runaway, incorporating thermal management systems, and implementing battery management systems that monitor and control the battery's charging and discharging cycles. These systems may be expensive and require constant power to function properly.

There is a need for a system, device or method that will provide a more energy efficient and/or cost-efficient indication that thermal runaway is imminent which may be utilized to generate e.g. warnings or alerts.

From the above, it is understood that there is a need for improvements and/or alternatives.

### SUMMARY

According to a first aspect of the disclosure, a warning system for providing a warning indicating a thermal runaway of a battery is provided. The warning system comprises an electromechanical switch configured to be operatively connected to a pressure actuatable device of the battery device such that actuation of the pressure actuatable device causes activation of the electromechanical switch, and an electric conduit connected to the electromechanical switch and configured to be connected to an indicating device for providing an indication of thermal runaway of the battery device responsive to the activation of the electromechanical switch and independently from battery control circuitry configured to control the battery device. The first aspect of the disclosure may seek to achieve a more energy efficient warning system. A technical benefit may include that the warning system may be operated independently from components having a high energy consumption and may allow for a warning to be generated in case of thermal runaway even when the battery control circuitry is shut down.

Optionally, in some examples, the battery device may comprise a pressure relief valve arranged to control an over pressure relief path of the battery device. A technical benefit may include that the gases and particles freed during a thermal runaway may be evacuated from the battery device and the pressure inside the battery device may be reduced.

Optionally, in some examples, the pressure actuatable device may be formed by the pressure relief valve. A technical benefit may include that a warning system may be implemented using existing components commonly found in a battery device. Another technical benefit may include that a warning system with less complexity may be achieved.

Optionally, in some examples, the pressure actuatable device may be formed by a pressure switch device of the battery device. A technical benefit may include that such pressure switch devices are commonly available in other applications which may allow for a more cost-efficient pressure actuatable device.

Optionally, in some examples, the warning system may further comprise control circuitry connected to the electric conduit, the control circuitry may comprise processing circuitry configured to control the warning system. A technical benefit may include that the control circuitry may enable additional functionality and/or improve the reliability and robustness of the warning system.

Optionally, in some examples, the control circuitry may be configured to be connected to a power source for powering the control circuitry independently from the battery device. A technical benefit may include that the warning system may enable additional functionality in an energy efficient manner.

Optionally, in some examples, the power source may be a dedicated battery for powering the control circuitry such as a 9V battery. A technical benefit may include that the warning system may enable additional functionality in an energy efficient manner.

Optionally, in some examples, the processing circuitry may be configured to obtain sensor data associated with the voltage in the electric conduit from one or more sensor(s) configured to monitor the electric conduit and wherein the processing circuitry may be further configured to control the indicating device based on the sensor data. A technical benefit may include that a warning system capable of providing a more precise indication of a thermal runaway may be achieved.

Optionally, in some examples, the processing circuitry may be configured to perform self-diagnostic tests of the warning system. A technical benefit may include that a warning system with an improved reliability may be achieved.

Optionally, in some examples, the control circuitry may be configured to perform the self-diagnostic tests by controlling a diagnostic switching device of the warning system, such as a transistor or relay, to selectively connect the electric conduit to the power source. A technical benefit may include that a more energy efficient and accurate self-diagnostic test may be achieved.

Optionally, in some examples, the processing circuitry may be configured to responsive to a difference between the input voltage and the output voltage of the electric conduit obtained from the sensor data being within a voltage threshold control the indicating device to provide an indication for indicating a functional warning system and responsive to the difference between the input voltage and/or the output voltage of the electric conduit being outside said voltage threshold control the indicating device to provide an indication for indicating a non-functional warning system. A technical benefit may include that the user may be informed about a functional or non-functional warning system in a simple and cost-efficient manner.

Optionally, in some examples, the electromechanical switch may be configured to be selectively connected to an energy storage device such that the electromechanical switch in an inactive state may be configured to disconnect the energy storage device from the electric conduit and in an activated state may be configured to connect the energy storage device to the electric conduit. A technical benefit may include that the connection of the energy storage device may provide a more accurate manner of detecting that the electromechanical switch has been put in an activated state, which may improve the accuracy and reliability of the warning system.

Optionally, in some examples, the energy storage device and the power source may be configured to operate at different voltages. A technical benefit may include that a more accurate warning system may be achieved due to the voltages in the electric conduit shifting depending on the operational state of the warning system.

Optionally, in some examples, the electric conduit may be substantially without power when the electromechanical switch is inactive. A technical benefit may include that a more energy efficient warning system may be provided.

Optionally, in some examples, the warning system may comprise a plurality of electromechanical switches each being configured to be operatively connected to a pressure actuatable device of a battery device of a plurality of battery devices, wherein the electric conduit may be configured to be connected to the electromechanical switches and the indicating device for providing an indication of thermal runaway of the battery devices responsive to the activation of at least one of the electromechanical switches. A technical benefit may include that a warning system capable of providing an indication of thermal runaway in a plurality of battery devices in an energy-efficient manner may be provided.

Optionally, in some examples, the plurality of electromechanical switches may be arranged in a daisy chain configuration in the electric conduit. A technical benefit may include that a less complex and more cost-efficient warning system capable of providing an indication of thermal runaway in a plurality of battery devices may be provided.

Optionally, in some examples, the warning system may be configured to be integrated in a vehicle.

According to a second aspect of the disclosure, a battery arrangement may be provided. The battery arrangement comprises the warning system according to any of the examples provided herein and a battery device, the battery device comprises at least one battery cell, a housing enclosing the at least one battery cell and a pressure actuatable device. The second aspect of the disclosure may seek to achieve a more energy efficient battery arrangement with a reliable manner of providing an indication of a thermal runaway. A technical benefit may include that the warning system may be operated independently from components having a high energy consumption and may allow for a warning to be generated in case of thermal runaway even when the battery control circuitry is shut down.

Optionally, in some examples, the battery device may comprise an over pressure relief path and a pressure relief valve arranged to control the over pressure relief path. A technical benefit may include that the gases and particles freed during a thermal runaway may be evacuated from the battery device and the pressure inside the battery device may be reduced.

The disclosed aspects, examples, and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary vehicle according to an example.

FIG. 2 is a schematic block diagram of aspects of a battery arrangement according to an example.

FIG. 3 is a schematic block diagram of aspects of a battery arrangement according to another example.

FIG. 4 is a schematic block diagram of aspects of a battery arrangement according to yet another example.

FIG. 5A is a schematic block diagram of aspects of a battery arrangement and a battery device of a battery arrangement according to an example.

FIG. 5B is a schematic block diagram of aspects of a battery arrangement and a battery device of a battery arrangement according to an example.

FIG. 5C is a schematic block diagram of battery control circuitry and a warning system according to an example.

FIG. 6 depicts a schematic cross-section view of a pressure relief valve and electromechanical switch according to an example.

FIG. 7 is an exemplary method for providing an indication of thermal runaway according to an example.

FIG. 8 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

As previously indicated, thermal runaway of a battery cell may cause release of toxic gases, fire, and/or explosion. In order to reduce a risk of e.g. injury, or even death, of persons in a vicinity of a battery cell undergoing thermal runaway, a reliable warning system is desired. Such warning systems are especially important for vehicles as these are generally operated by a driver that should evacuate the vehicle immediately in case of thermal runaway of one or more battery cells of the vehicle. In addition to this, some vehicles offer live in possibilities for a driver which means that a driver may sleep or rest in a vehicle. This is common for heavy duty vehicles such as trucks.

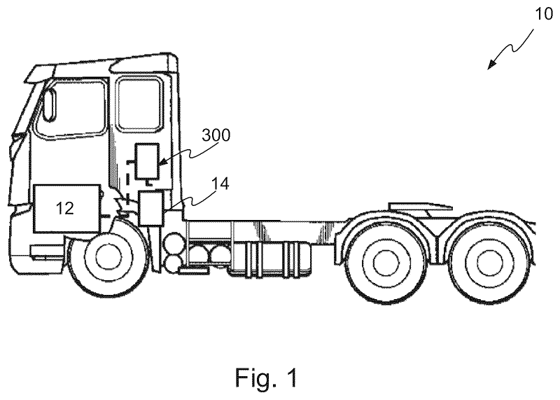

FIG. 1 is an exemplary view of a vehicle 10 according to an example is shown. The vehicle is shown as a truck, but the teachings of the present disclosure are applicable not only to any type of vehicle 10, but to any type of battery system, not only battery systems for vehicles 10.

The vehicle 10 of FIG. 1 is an, at least partly, electrically propelled vehicle 10. To this end, the vehicle 10 comprises one or more motors 12 arranged to propel the vehicle 10 and one or more electrical power sources 14 configured to provide power to the one or more motors 12 and/or other functionality of the vehicle 10. The vehicle further comprises a warning system 300 for providing an indication of thermal runaway in one or more battery cells of the vehicle 10.

Although the vehicle 10 of FIG. 1 is described as an, at least partly, electrically propelled vehicle 10, the vehicle may, in some examples, be a vehicle 10 propelled solely by a combustion engine. In such examples, electrical power sources 14 may be provided to power electronics controlling the combustion engine (fuel injection etc.) or comfort systems of the vehicle (thermal control of a cabin of the vehicle, auxiliary equipment such as refrigerators, GPS etc.). In short, the warning system 300 may be utilized with any suitable electrical power source 14 at risk of experiencing thermal runaway or similar effects.

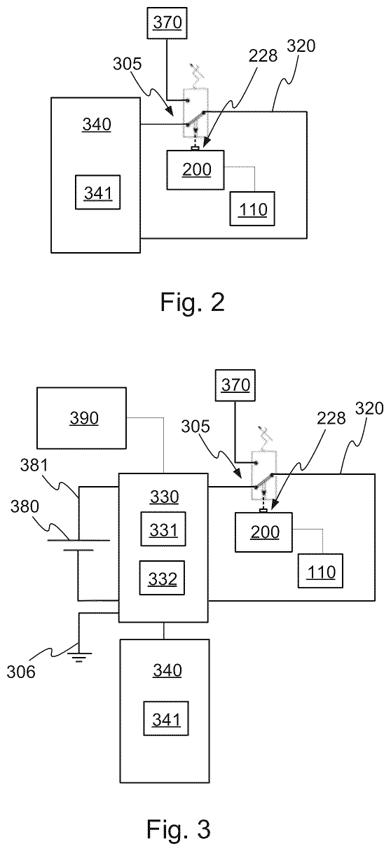

FIG. 2 is an exemplary block diagram of a warning system 300 according to some examples of the present disclosure. The warning system 300 is for providing a warning indicating a thermal runaway of a battery device 200. The warning system 300 comprises an electrical conduit 320. The electrical conduit 320 may be any suitable conduit conducting electricity such as a conducting wire, a trace on a circuit board etc.

The warning system 300 further comprises an electromechanical switch 305. The electrical conduit 320 is connected to, i.e. electrically connected to, the electromechanical switch 305. The electrical conduit 320 is thus configured to provide electrical power to the electromechanical switch 305.

The electromechanical switch 305 is configured to be operatively connected to a pressure actuatable device 228 of the battery device 200. The electromechanical switch 305 may be operatively connected to the pressure actuatable device 228 such that actuation of the pressure actuatable device 228 causes activation of the electromechanical switch 305.

Activation of the electromechanical switch 305 may cause a detectable change in the electrical conduit 320 allowing for issuing the indication of thermal runaway. The detectable change may for example be the activation of the electromechanical switch causing the electrical conduit 320 to connect to or disconnect from a load or power source or causing the electrical conduit 320 to open or close.

The electromechanical switch 305 may be any type of suitable electromechanical switch 305 such as: a toggle switch operated by moving a lever back and forth to open or close the electrical conduit 320, a push button switch operated by pressing an actuation element such as a button to open or close the electrical conduit 320, a rotary switch operated by a rotatable actuation element rotatable to different positions to open or close the electrical conduit 320, a limit switch activated by the physical movement of another part such as the pressure actuatable device 228 to open or close the electrical conduit 320 or a Reed switch operated by a magnetic field, for example a magnetic field generated by the pressure actuatable device 228, to activate the electromechanical switch 305.

The electromechanical switch 305 may be configured to close the electrical conduit 320 upon actuation of the pressure actuatable device 228. The pressure actuatable device 228 may be actuatable by an over-pressure in the battery device 200 indicating a thermal runaway in said battery device 200.

The electrical conduit 320 is configured to be connected to an indicating device 340 for providing an indication of thermal runaway of the battery device 200 responsive to the activation of the electromechanical switch 305. The electrical conduit 320 is further configured to be connected to the indicating device 340 for providing an indication of thermal runaway of the battery device 200 independently from battery control circuitry 110 configured to control the battery device 200.

The warning system 300 may thus be provided to operate independently from the battery control circuitry 110 configured to control the battery device 200. This may allow for the warning system 300 to be implemented in an energy-efficient manner and allows for the battery control circuitry 110 to be shut down when the vehicle is not operating. In conventional thermal runaway alarm systems, the battery control circuitry 110 will always be active, which will draw power from the battery device 200 and/or other battery devices of the vehicle.

Advantageously, the electric conduit 320 may be substantially without power when the electromechanical switch 305 is inactive.

Upon activation of the electromechanical switch 320, an activation indication is provided to the indicating device 340 via the electric conduit 320. Responsive to the activation indication, the indicating device 340 may provide an indication to indicate thermal runaway in the battery device 200. The indication provided by the indicating device 340 may vary depending on the type of indicating device 340. In one example, the indicating device 340 may comprise a speaker, whereby the indication may be in the form of an audible warning. In one example, the indicating device 340 may comprise one or more indicating light sources, whereby the indication may be in the form of an activation or deactivation of said indicating light sources. In one example, the indicating device 340 may comprise a display, whereby the indication may be in form of a visual indication provided by means of said display.

The indicating device 340 may in one example comprise indicating device circuitry 341. The indicating device circuitry 341 may be configured to receive the activation indication and control the indicating device 340 based on the warning indication. The indicating device circuitry 341 may comprise sensor circuitry configured to be connected to the electric conduit 320. In some examples, the indicating device circuitry 341 may comprise voltage sensor circuitry configured to monitor the voltage in the electric conduit 320. In some examples, the indicating device circuitry 341 may comprise current sensor circuitry configured to monitor the current in the electric conduit 320. In one example, the indicating device circuitry 341 may be configured to obtain sensor data associated with the voltage in the electric conduit 320 from one or more sensor(s) 390 configured to monitor the electric conduit 320.

Further referencing FIG. 2, the electromechanical switch 305 may be configured to be selectively connected to an energy storage device 370. The electromechanical switch 305 may be configured to be selectively connected to the energy storage device 370 such that the electromechanical switch 305 in an inactive state is configured to disconnect the energy storage device 370 from the electric conduit 320 and in an activated state is configured to connect the energy storage device 370 to the electric conduit 320. Upon activation of the electromechanical switch 305, said electromechanical switch 305 switches from the inactive state to the activated state. In the activated state, the electromechanical switch 305 connects, i.e. electrically connects, the energy storage device 370 to the electric conduit 320. This will provide an activation indication to the indicating device 340 (e.g., a warning device), whereby the indicating device 340 may provide a user with an indication based on the activation indication. The activation indication is thus provided by the energization of the electric conduit 320 by the energy storage device 370. The energization may be detected by means of the sensor circuitry of the indicating device circuitry 341, e.g. the aforementioned one or more sensors.

The energy storage device 370 may be in the form of a battery. In one example, the battery device 200 may be comprised in a battery system and the energy storage device 370 may be provided in the form of another battery device of the battery system.

In one example, the warning system 300 may be configured to be integrated in the vehicle 10. The vehicle 10 may thus comprise the warning system 300. The warning system 300 may be partially or entirely integrated in the vehicle 10. Accordingly, all or some of the components of the warning system 300 may be integrated in the vehicle 10.

The indicating device 340 may for example be integrated in the dashboard of the vehicle 10. Accordingly, the indicating device 340 may be provided in the form of an element in the user interface of the dashboard of the vehicle 10.

In one example, the indicating device 340 may be provided in the form of a stand-alone device. The indicating device 340 may be configured to be mounted in the interior of the vehicle 10, e.g. the cabin. For example, the indicating device 340 may be provided as a indicating device 340 with an internal power source such as a battery or may be configured to be connected to a power source of the vehicle 10.

Referencing FIG. 3, the warning system 300 may comprise circuitry for providing additional functionality to the warning system 300.

The warning system 300 may comprise control circuitry 330. The control circuitry 330 may be connected to, i.e. electrically connected to, the electric conduit 320. The control circuitry 330 may comprise processing circuitry 331. The processing circuitry 331 may be configured to control the warning system 300.

In the depicted example, the control circuitry 330 is depicted as separate from the indicating device circuitry 341. It may however be envisioned that the indicating device circuitry 341 and the control circuitry 330 are provided as a single circuitry and/or that the functions described herein may be distributed in any manner between the indicating device circuitry 341 and the control circuitry 330.

The control circuitry 330 may be configured to be connected to a power source 380 for powering the control circuitry 330 independently from the battery device 200. The control circuitry 330 may thus be operable even in cases where the battery device 200 is rendered inoperable by thermal runaway.

In one example, the power source 380 may be a dedicated battery for powering the control circuitry 330. The power source 380 may thus be a battery provided solely for powering the control circuitry 330 and in some examples, the indicating device 340. In one example, the power source 380 may be a 9V battery.

Referencing FIG. 3, the processing circuitry 331 may be configured to obtain sensor data associated with the voltage in the electric conduit 320 from one or more sensor(s) 390. The one or more sensor(s) 390 may be configured to monitor the electric conduit 320. The processing circuitry 331 may be configured to control the indicating device 340 based on the sensor data.

In one example, the energy storage device 370 and the power source 380 may be configured to operate at different voltages. The energy storage device 370 may in some examples be a 24V battery.

The control circuitry 330 may be connected, i.e. electrically connected, to the power source 380 via a control circuitry conduit 381. The control circuitry conduit 381 may be any suitable conduit conducting electricity such as a conducting wire, a trace on a circuit board etc. The control circuitry conduit 381 may connect the two poles of the power source 380 to the control circuitry 330. The control circuitry 330 may be connected, i.e. electrically connected, to a ground connection 306.

Further referencing FIG. 3, the electromechanical switch 305 may be configured to selectively connect the energy storage device 370 to the electric conduit 320.

Upon the electromechanical switch 305 being in the inactive state, the electromechanical switch 305 may be configured to disconnect the energy storage device 370 from the electric conduit 320. Upon activation of the electromechanical switch 305 and upon the electromechanical switch 305 being in the activated state, the electromechanical switch 305 may be configured to connect the energy storage device 370 to the electric conduit 320. This will cause a change in the voltage in the electric conduit 320 and a consequent change in the sensor data obtained from the one or more sensor(s) 390. In response to detecting said change in sensor data, the processing circuitry 331 may control the indicating device 340.

The processing circuitry 331 may be configured to determine that the voltage in the

electrical conduit 320 exceeds a thermal runaway indication threshold and cause control of the indicating device 340 to provide a user an indication indicating thermal runaway in the battery device 200.

The control circuitry 330 may further enable self-diagnostic testing of the warning system 300. The self-diagnostic tests may be performed periodically. The self-diagnostic tests may be utilized for indicating that the warning system 300 is functional.

The processing circuitry 331 may be configured to perform the self-diagnostic tests of the warning system 300.

The processing circuitry 331 may be configured to perform the self-diagnostic tests by controlling a diagnostic switching device 332. In some embodiments, the diagnostic switching device 332 may be a transistor or a relay. The warning system 300 may comprise the diagnostic switching device 332. The processing circuitry 331 may be configured to perform the self-diagnostic tests by controlling the diagnostic switching device 332 to selectively connect the electric conduit 320 to the power source 380.

In the depicted example, the diagnostic switching device 332 is provided as a part of the control circuitry 330. It may however be envisioned that the diagnostic switching device 332 is provided as a part separate from the control circuitry 330.

The diagnostic switching device 332 may be configured operate in a diagnostic state and in an inactive state. In the inactive state, the diagnostic switching device 332 may be configured to disconnect the power source 380 from the electric conduit 320 such that the power source 380 is disconnected from the electric conduit 320. In the diagnostic state, the diagnostic switching device 332 may be configured to connect the power source 380 to the electrical conduit 320 such that the power source 380 energizes the electric conduit 320.

The diagnostic switching device 332 may be configured to switch between the diagnostic state and the activated state responsive to a diagnostics instruction issued by the control circuitry 330, i.e. the processing circuitry 331. The diagnostic instruction may be issued periodically at set time intervals or in response to the processing circuitry 331 receiving a user initiated diagnostics prompt, for example via a user interface.

In the diagnostic state, the power source 380 provides a current to the electric conduit 320 via the diagnostic switching device 332. This allows for the input and output voltage to the electric conduit 320 to be monitored by means of the one or more sensors 390. If a substantial difference between the input and output voltage is detected, it may indicate that the electric conduit 320 is damaged, the power source 380 is depleted or close to depletion or other signs of the warning system 300 being non-functional and an indication to the user may be provided accordingly, for example by means of the indicating device 340.

The processing circuitry 331 may be configured to responsive to a difference between the input voltage and the output voltage of the electric conduit 320 obtained from the sensor data being within a voltage threshold control the indicating device 340 to provide an indication for indicating a functional warning system. Responsive to the difference between input voltage and output voltage of the electric conduit 320 being outside said voltage threshold, the processing circuitry 331 may be configured to control the indicating device 340 to provide an indication for indicating a non-functional warning system.

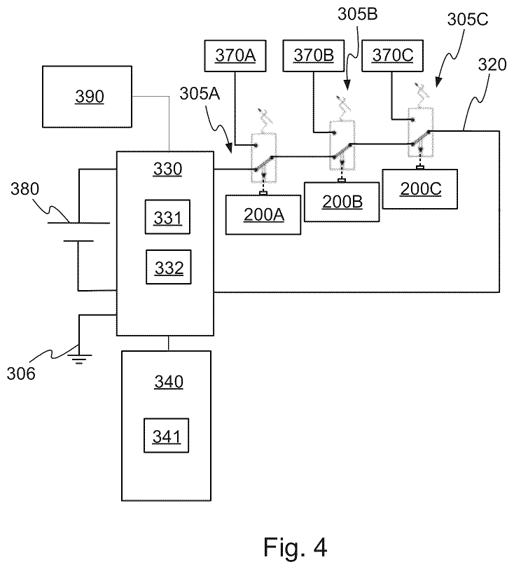

In many cases, for example in a vehicle 10, a plurality of battery devices may be provided. The warning system 300 may be configured to detect and provide indication of thermal runaway for a plurality of battery devices. FIG. 4 depicts an example of such a warning system.

A battery system comprises a plurality of battery devices 200A-C. In the depicted example, the battery system comprises at least three battery devices but any number of battery devices may be envisioned.

The warning system 300 may comprise a plurality of electromechanical switches 305A-C. Each electromechanical switch 305A-C may be configured to be operatively connected to a pressure actuatable device of one of the plurality of the battery devices 200A-C. The electric conduit 320 is configured to be connected to the electromechanical switches 305A-C. The electric conduit 320 is configured to be connected to the indicating device 340 for providing an indication of thermal runaway of the battery device 200A-C responsive to the activation of at least one of the electromechanical switches 305A-C.

The electromechanical switches 305A-C may each function in the manner previously described with reference to FIG. 2-3. Accordingly, each battery device 200A-C may comprise a pressure actuatable device, whereby one of the electromechanical switches 305A-C may be connected to each pressure actuatable device.

In the depicted example, a first electromechanical switch 305A may be operatively connected to a pressure actuatable device of a first battery device 200A, a second electromechanical switch 305B may be operatively connected to a pressure actuatable device of a second battery device 200B and a third electromechanical switch 305C may be operatively connected to a pressure actuatable device of a third battery device 200C.

In the depicted example the plurality of electromechanical switches 305A-C may be arranged in a daisy chain configuration in the electric conduit 320. As the skilled person is well aware, in a daisy chain configuration, the plurality of electromechanical switches 305A-C are connected in a series such that each subsequent electromechanical switch is connected to the one before it. In the event of any of the electromechanical switches 305A-C getting activated, the activated electromechanical switch 305A-C connects the electric conduit 320 to an energy storage device 370A-C.

In the depicted example, each of the electromechanical switches 305A-C is configured to selectively connect the electric conduit 320 to a separate energy storage device 370A-C. It may however also be envisioned that the electromechanical switches 305A-C are configured to selectively connect the electric conduit 320 to a common energy storage device 370.

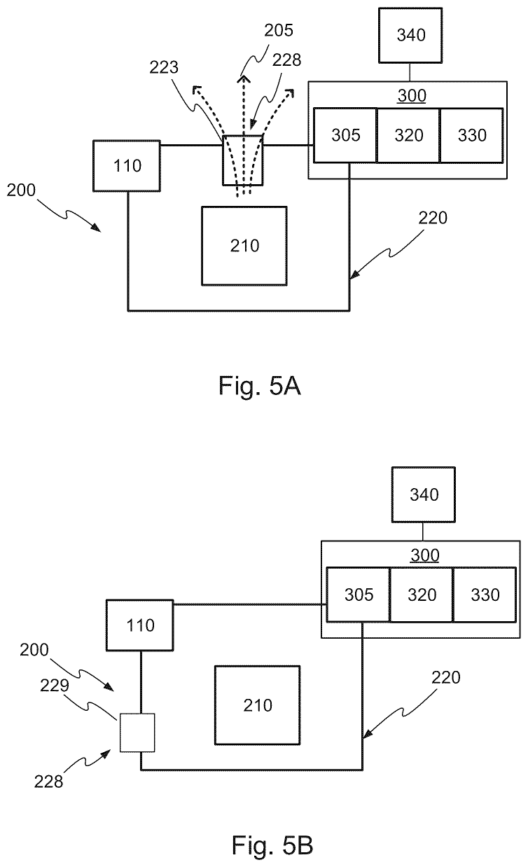

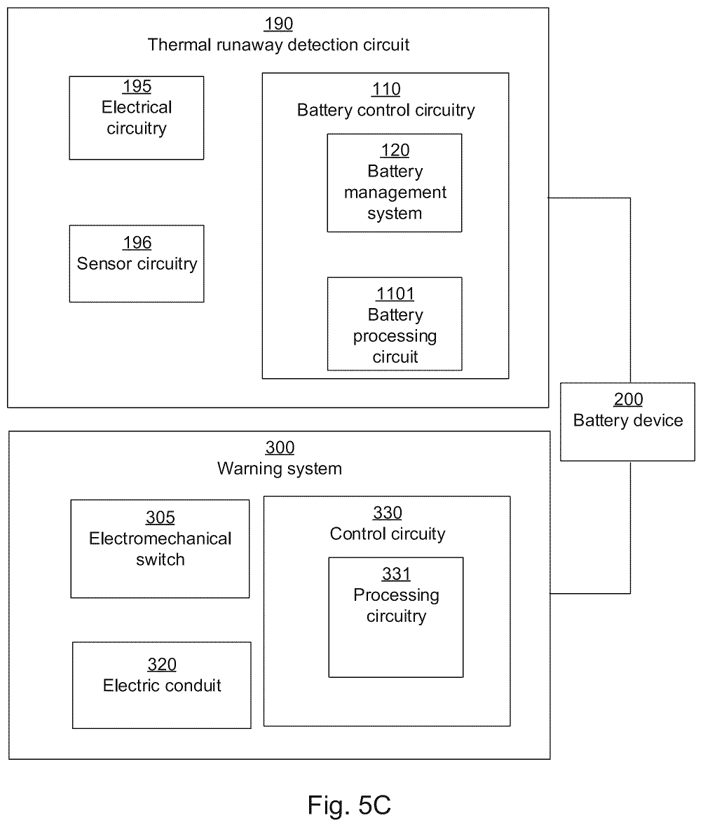

FIG. 5A-B shows an exemplary view of a battery device 200 and a battery arrangement comprising the battery device 200 and the warning system 300. The battery device 200 comprises one or more battery cells 210. In FIG. 5A-B, only one battery cell 210 is shown, but the battery device 200 may comprise any number of battery cells 210. The battery device 200 further comprises a housing 220 enclosing the battery cell(s) 210.

The battery device 200 further comprises the pressure actuatable device 228. The pressure actuatable device 228 may be configured to be actuated in response to the pressure in the battery device 200, e.g. the pressure inside the housing 220, exceeding a pressure indicating thermal runaway.

In some examples, the battery device 200 comprises a pressure relief valve 223. The pressure relief valve 223 may be arranged to control an over pressure relief path 205 of the battery device 200.

As will be further explained, the pressure actuatable device 228 may be formed by the pressure relief valve 223 or may be provided in addition to the pressure relief valve 223.

In FIG. 5A-B, the housing 220 is provided with the pressure relief valve 223. This is one example, and pressure relief valves 223 may, additionally, or alternatively, be provided in e.g. casings of the battery cells 210. The pressure relief valve 223 is provided in order to prevent the battery device 200 from being disfigured, exploding or rupturing due to excessive pressure build-up within the housing 220. Such pressure build-up may result from the battery cell 210 being charged. Venting of gas during charging may be comparably harmless as a comparably small volume of gas is released. If a thermal runaway occurs, gases released will have a comparably higher temperature and a volume of gases released will be comparably greater.

The vented gases will escape the housing 220 through the pressure relief valve 223 along the over pressure relief path 205 of the battery device 200. The over pressure relief path 205 is a fluid path of vented gases (heated fumes) and is a path originating inside the housing 220, passing through the pressure relief valve 223 and ending outside the housing 220.

FIG. 5A schematically depicts a battery arrangement according to an example. In the depicted example, the pressure actuatable device 228 is formed by the pressure relief valve 223. The electromechanical switch 305 is thus operatively connected to the pressure relief valve 223. Upon the pressure relief valve 223 opening, the electromechanical switch 305 is activated. This may be achieved by the pressure relief valve 223 engaging the electromechanical switch 305 upon opening thereby causing the activation of the electromechanical switch 305.

FIG. 5B schematically depicts a battery arrangement according to an example. In the depicted example, the pressure actuatable device 228 is formed by a pressure switch device 229 of the battery device 200. In the depicted example, the pressure switch device 229 is provided in a battery device 200 without a pressure relief valve 223. It may however also be envisioned that the pressure switch device 229 is provided in combination with said pressure relief valve 223.

Pressure switch devices are well-established in the prior art and any type of suitable pressure switch device may be utilized.

In the depicted example, a pressure switch device 229 is arranged in the housing 220. The pressure switch device 229 is arranged in an aperture of the housing 220. The pressure switch device 229 may be arranged in a sealed manner in said aperture. The electromechanical switch 305 may be provided in the pressure switch device 229.

The pressure switch device 229 may comprise a diaphragm or piston configured to move in response to changes in the pressure in the battery device 200. When the pressure reaches a preset threshold, the diaphragm or piston may cause activation of the electromechanical switch 305. In one example, the pressure switch device 229 may comprise a mechanical linkage connected to the electromechanical switch 305 such that movement of the diaphragm or piston causes the mechanical linkage to move in turn causing activation of the electromechanical switch 305.

FIG. 5C schematically depicts a block diagram of the battery control circuitry, a thermal runaway detection circuit and a warning system according to an example.

In the depicted example, the vehicle 10 may comprise a thermal runaway detection circuit 190 configured to detect thermal runaway in the battery device 200. The warning system 300 may be provided independently from the thermal runaway detection circuit 190. Thus, the vehicle 10 may comprise both the thermal runaway detection circuit 190 and the warning system 300 operating independently from each other.

The thermal runaway detection circuit 190 may comprise electrical circuitry 195. The thermal runaway detection circuit 190 may comprise the battery control circuitry 110.

In one example, the battery control circuitry 110 may comprise a battery management system 120. The battery management system 120 may be configured to control the battery device 200. As the skilled person is aware, a Battery Management System (BMS) is a common component in battery-powered devices and systems, for enabling safe and efficient operation of the battery. The battery management system 120 may provide any relevant functionality associated with a conventional battery management system. Such functionality may include but not be limited to monitoring of parameters associated with the one or more battery device(s) 200. The battery management system 120 may be configured to monitor for example the voltage, current, temperature, pressure and/or state of charge (SOC) of individual cells 210 and the entire battery device(s) 200.

In some examples, the battery management system 120 may be configured to control the cells 210 of the battery device(s) 200 such that they are charged and discharged evenly to prevent overcharging or deep discharging, which can damage cells and reduce battery life.

In some examples, the battery management system 120 may be configured to safeguard against conditions such as overcharging, over-discharging, over-current, thermal runaway and over-temperature, which can cause battery failure or safety hazards.

In some examples, the battery management system 120 may be configured to provide data and status information to vehicle control systems, such as ECUs or user interfaces.

The electrical circuitry 195 may be any suitable conduit conducting electricity such as a conducting wire, a trace on a circuit board etc. The electrical circuitry 195 may be electrically connected to the battery control circuitry 110 and configured to provide an electrical connection between the battery control circuitry 110 and peripheral circuits. The peripheral circuits may be any suitable circuit such as, but not limited to, further processing circuits, memory circuits, amplifier circuits, control circuits etc. In an advantageous example, the peripheral circuits may be sensor circuitry 196 such as, but not limited to, voltage sensor circuits, current sensor circuits, temperature sensor circuits, etc.

In the depicted example, the thermal runaway detection circuit 190 comprises the sensor circuitry 196. The electrical circuitry 195 may be configured to connect the battery control circuitry 110 to the sensor circuitry 196. In some examples, the sensor circuitry 196 may comprise voltage sensor circuitry, temperature sensor circuitry and/or current sensor circuitry.

The battery control circuitry 110 may comprise a battery processing circuit 1101. The battery management system 120 may be comprised in the battery processing circuit 1101. The battery processing circuit 1101 may be any suitable processing circuit 1101. Generally, battery devices are provided with processing circuits of some sort configured to monitor e.g. a temperature and a voltage of an associated battery or battery cell(s). The battery processing circuit 1101 of the thermal runaway detection circuit 100 may very well be such a processing circuit. In some examples, the battery processing circuit 1101 of the thermal runaway detection circuit 190 is a processing circuit 1101 electrically connected to the sensor circuit 196 by the electrical circuitry 195. With that said, the sensor circuit 196 may be connected to the battery processing circuit 1101 of the thermal runaway detection circuit 190 via the electrical circuitry 195, but the connection may be via further (processing) circuits.

The processing circuit 110 is configured to generate thermal runaway indication 101 responsive to determining that a thermal runaway is occurring. The battery processing circuit 1101 may be configured to obtain the data from the sensor circuitry 196 and provide that data to the battery processing circuit 1101.

The battery processing circuit 1101 may be configured to be based on data obtained by the sensor circuitry 196 determine that a thermal runaway is occurring in the one or more battery device(s) 200. The battery processing circuit 1101 may be configured to generate the thermal runaway indication responsive to determining that a thermal runaway is occurring. The battery processing circuit 1101 may be configured to generate the thermal runaway indication to a vehicle control system and/or a user interface of the vehicle 10, thereby enabling a driver or an operator to be alerted of the thermal runaway.

As aforementioned, the warning system 300 may be provided independently from the battery control circuitry 110. Thus, the warning system 300 may be configured to be active also when the battery control circuitry 110 is idle or inactive. The warning system 300 may thus be configured to be active also when the battery control circuitry is idle or inactive.

Worded differently, the battery control circuitry 110 may be configured to operate in an active mode wherein the battery control circuitry 110 is configured to control and/or monitor the battery device 200. The battery control circuitry 110 may be further configured to operate in an inactive or idle mode, wherein the battery control circuitry 110 does not provide any control and/or monitoring of the battery device 200. The warning system 300 is configured to operate and provide a warning indicating a thermal runaway of the battery device 200 when the battery control circuitry 110 operates in the inactive or idle mode and in some embodiments also when the battery control circuitry 110 operates in the active mode. Notably, the warning system 300 may be operational independently from the sensor circuitry 196.

FIG. 6 schematically depicts an example of a pressure relief valve 223 and aspects of an electromechanical switch 305 of a battery arrangement according to one example. In the depicted example, the electromechanical switch 305 is provided in the pressure relief valve 223 of the battery device 200.

The pressure relief valve 223 may comprise a sealing member 2232. The scaling member 2232 may be arranged in the over pressure relief path 205. The sealing member 2232 may be configured to open responsive to the pressure in the pressure relief path 205 exceeding a critical pressure level. Advantageously, the critical pressure level may be associated with a pressure level indicating a thermal runaway in the battery device 200.

The electromechanical switch 305 may comprise an actuatable member 3052. The actuatable member 3052 may be arranged at the sealing member 2232 such that opening of the sealing member 2232 causes the actuation of the actuatable member 3052 and activation of the electromechanical switch 305.

The sealing member 2232 may comprise a membrane. The pressure relief valve 223 may further comprise a lid 2231. The membrane may be configured to rip at the aforementioned critical pressure level in the pressure relief path 205 and press against the lid 2231. The actuatable member 3052 may be arranged between the membrane and the lid 2231. In the depicted example, the actuatable member 3052 is arranged such that the membrane will force the actuatable member 3052 towards the lid 2231, whereby the engagement between the actuatable member 3052 and the lid 2231 causes actuation of the actuatable member 3052 and the activation of the electromechanical switch 305.

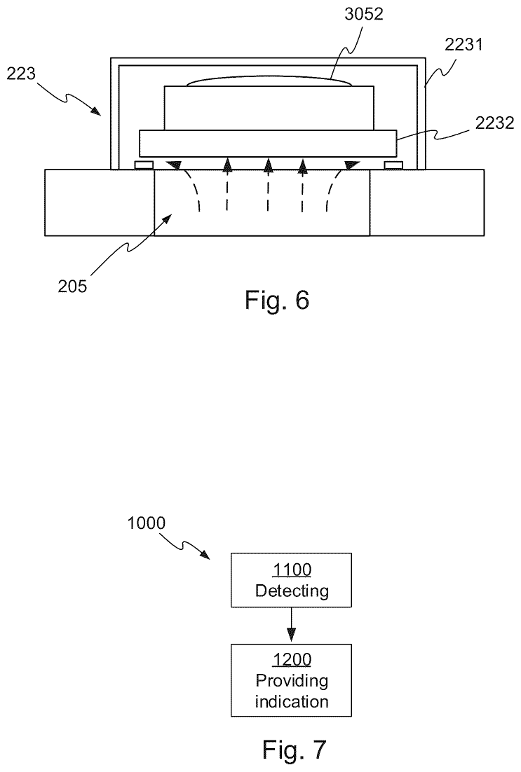

In FIG. 7 a method 1000 for providing a warning indicating a thermal runaway of a battery device 200 is shown. The method 1000 comprises detecting 1100 an activation of the electromechanical switch 305. The method 1000 further comprises providing 1200 an indication of thermal runaway of the battery device 200 responsive to the activation of the electromechanical switch 305 as taught herein.

In some examples, the control circuitry 330 is configured to perform the method of FIG. 7.

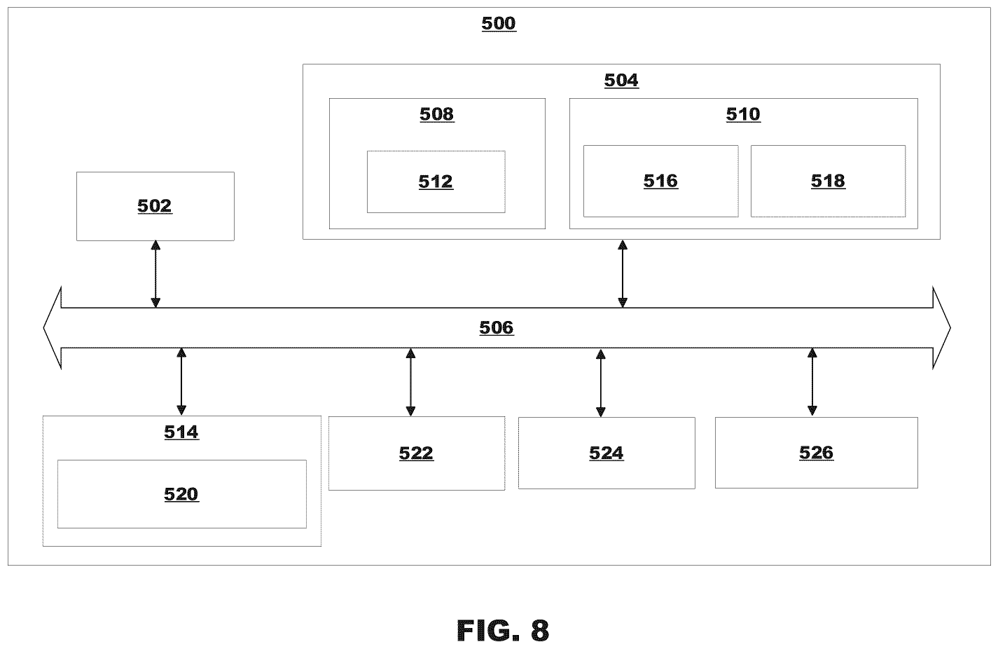

FIG. 8 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN, an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

In one aspect, a warning system or battery arrangement according to any of the following examples may be provided.

Example 1: A warning system (300) for providing a warning indicating a thermal runaway of a battery device (200), the warning system (300) comprising: an electromechanical switch (305) configured to be operatively connected to a pressure actuatable device (228) of the battery device (200) such that actuation of the pressure actuatable device (228) causes activation of the electromechanical switch (305), and an electric conduit (320) connected to the electromechanical switch (305) and configured to be connected to an indicating device (340) for providing an indication of thermal runaway of the battery device (200) responsive to the activation of the electromechanical switch (305) and independently from battery control circuitry (110) configured to control the battery device (200).

Example 2: The warning system (300) of example 1, wherein the battery device (200) comprises a pressure relief valve (223) arranged to control an over pressure relief path (205) of the battery device (200).

Example 3: The warning system (300) of example 2, wherein the pressure actuatable device (228) is formed by the pressure relief valve (223).

Example 4: The warning system (300) of example 1 or 2, wherein the pressure actuatable device (228) is formed by a pressure switch device (229) of the battery device (200).

Example 5: The warning system (300) of any of examples 1-4, further comprising control circuitry (330) connected to the electric conduit (320), the control circuitry (330) comprising processing circuitry (331) configured to control the warning system (300).

Example 6: The warning system of example 5, wherein the control circuitry (330) is configured to be connected to a power source (380) for powering the control circuitry (330) independently from the battery device (200).

Example 7: The warning system (300) of example 6, wherein the power source (380) is a dedicated battery for powering the control circuitry (330) such as a 9V battery.

Example 8: The warning system (300) of any of examples 5-7, wherein the processing circuitry (331) is configured to obtain sensor data associated with the voltage in the electric conduit (320) from one or more sensor (390) configured to monitor the electric conduit (320) and wherein the processing circuitry (331) is further configured to control the indicating device (340) based on the sensor data.

Example 9: The warning system (300) of any of examples 5-8, wherein the processing circuitry (331) is configured to perform self-diagnostic tests of the warning system (300).

Example 10: The warning system (300) of example 9, wherein the control circuitry (330) is configured to perform the self-diagnostic tests by controlling a diagnostic switching device (332) of the warning system (300), such as a transistor or relay, to selectively connect the electric conduit (320) to the power source (380).

Example 11: Warning system (300) of example 10, wherein the processing circuitry (331) is configured to responsive to a difference between the input voltage and the output voltage of the electric conduit (320) obtained from the sensor data being within a voltage threshold control the indicating device (340) to provide an indication for indicating a functional warning system and responsive to the difference between the input voltage and/or the output voltage of the electric conduit (320) being outside said voltage threshold control the indicating device (340) to provide an indication for indicating a non-functional warning system.

Example 12: Warning system (300) of any of examples 1-11, wherein the electromechanical switch (305) is configured to be selectively connected to an energy storage device (370) such that the electromechanical switch (305) in an inactive state is configured to disconnect the energy storage device (370) from the electric conduit (320) and in an activated state is configured to connect the energy storage device (370) to the electric conduit (320).

Example 13: Warning system (300) of example 12, wherein the energy storage device (370) and the power source (380) are configured to operate at different voltages.

Example 14: Warning system (300) of any of examples 1-13, wherein the electric conduit (320) is substantially without power when the electromechanical switch (305) is inactive.

Example 15: Warning system (300) of any of examples 1-14, wherein the warning system (300) comprises a plurality of electromechanical switches (305A, 305B, 305C) each being configured to be operatively connected to a pressure actuatable device (228) of a battery device (200) of a plurality of battery devices (200A, 200B, 200C), wherein the electric conduit (320) is configured to be connected to the electromechanical switches (305A, 305B, 305C) and the indicating device (340) for providing an indication of thermal runaway of the battery devices (200A, 200B, 200C) responsive to the activation of at least one of the electromechanical switches (305A, 305B, 305C).

Example 16: Warning system (300) of example 15, wherein the plurality of electromechanical switches (305A, 305B, 305C) are arranged in a daisy chain configuration in the electric conduit (320).

Example 17: Warning system (300) of any of examples 1-16, further configured to be integrated in a vehicle (10).

Example 18: Battery arrangement comprising the warning system (300) of any of examples 1-17, an indicating device (340) and a battery device (200), the battery device (200) comprising at least one battery cell (210), a housing (220) enclosing the at least one battery cell (210) and a pressure actuatable device (228).

Example 19: Battery arrangement of example 18, wherein the battery device (200) comprises an over pressure relief path (205) and a pressure relief valve (223) arranged to control the over pressure relief path (205).

Example 20: Battery arrangement of example 18, wherein the battery device (200) comprises an over pressure relief path (205) and a pressure relief valve (223) arranged to control the over pressure relief path (205), wherein the pressure actuatable device (228) is formed by the pressure relief valve (223), wherein the warning system (300) further comprises control circuitry (330) connected to the electric conduit (320), the control circuitry (330) comprising processing circuitry (331) configured to control the warning system (300), wherein the control circuitry (330) is configured to be connected to a power source (380) for powering the control circuitry (330) independently from the battery device (200), wherein the processing circuitry (331) is configured to obtain sensor data associated with the voltage in the electric conduit (320) from one or more sensor (390) configured to monitor the electric conduit (320) and wherein the processing circuitry (331) is further configured to control the indicating device (340) based on the sensor data, wherein the processing circuitry (331) is configured to perform self-diagnostic tests of the warning system (300), wherein the electromechanical switch (305) is configured to be selectively connected to an energy storage device (370) such that the electromechanical switch (305) in an inactive state is configured to disconnect the energy storage device (370) from the electric conduit (320) and in an activated state is configured to connect the energy storage device (370) to the electric conduit (320), and wherein the energy storage device (370) and the power source (380) are configured to operate at different voltages.

Example 21: A vehicle (10) comprising a warning system (300) of any of examples 1-17.

Example 22: A vehicle (10) comprising a battery arrangement of any of examples 18-20.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A warning system for providing a warning indicating a thermal runaway of a battery device, the warning system comprising:
an electromechanical switch configured to be operatively connected to a pressure actuatable device of the battery device such that actuation of the pressure actuatable device causes activation of the electromechanical switch, and
an electric conduit connected to the electromechanical switch and configured to be connected to an indicating device for providing an indication of thermal runaway of the battery device responsive to the activation of the electromechanical switch and independently from battery control circuitry configured to control the battery device.

2. The warning system of claim 1, wherein the battery device comprises a pressure relief valve arranged to control an over pressure relief path of the battery device.

3. The warning system of claim 2, wherein the pressure actuatable device is formed by the pressure relief valve.

4. The warning system of claim 1, wherein the pressure actuatable device is formed by a pressure switch device of the battery device.

5. The warning system of claim 1, further comprising control circuitry connected to the electric conduit, the control circuitry comprising processing circuitry configured to control the warning system.

6. The warning system of claim 5, wherein the control circuitry is configured to be connected to a power source for powering the control circuitry independently from the battery device.

7. The warning system of claim 6, wherein the power source is a dedicated battery for powering the control circuitry.

8. The warning system of claim 5, wherein the processing circuitry is configured to obtain sensor data associated with the voltage in the electric conduit from one or more sensor(s) configured to monitor the electric conduit and wherein the processing circuitry is further configured to control the indicating device based on the sensor data.

9. The warning system of claim 5, wherein the processing circuitry is configured to perform self-diagnostic tests of the warning system.

10. The warning system of claim 9, wherein the control circuitry is configured to perform the self-diagnostic tests by controlling a diagnostic switching device of the warning system to selectively connect the electric conduit to the power source.

11. The warning system of claim 10, wherein the processing circuitry is configured to responsive to a difference between the input voltage and the output voltage of the electric conduit obtained from the sensor data being within a voltage threshold control the indicating device to provide an indication for indicating a functional warning system and responsive to the difference between the input voltage and/or the output voltage of the electric conduit being outside said voltage threshold control the indicating device to provide an indication for indicating a non-functional warning system.

12. The warning system of claim 1, wherein the electromechanical switch is configured to be selectively connected to an energy storage device such that the electromechanical switch in an inactive state is configured to disconnect the energy storage device from the electric conduit and in an activated state is configured to connect the energy storage device to the electric conduit.

13. The warning system of claim 12, wherein the energy storage device and the power source are configured to operate at different voltages.

14. The warning system of claim 1, wherein the electric conduit is substantially without power when the electromechanical switch is inactive.

15. The warning system of claim 1, wherein the warning system comprises a plurality of electromechanical switches each being configured to be operatively connected to a pressure actuatable device of a battery device of a plurality of battery devices, wherein the electric conduit is configured to be connected to the electromechanical switches and the indicating device for providing an indication of thermal runaway of the battery devices responsive to the activation of at least one of the electromechanical switches.

16. The warning system of claim 15, wherein the plurality of electromechanical switches are arranged in a daisy chain configuration in the electric conduit.

17. The warning system of claim 1, further configured to be integrated in a vehicle.

18. A battery arrangement comprising the warning system of claim 1, an indicating device and a battery device, the battery device comprising at least one battery cell, a housing enclosing the at least one battery cell and a pressure actuatable device.

19. A battery arrangement of claim 18, wherein the battery device comprises an over pressure relief path and a pressure relief valve arranged to control the over pressure relief path, wherein the pressure actuatable device is formed by the pressure relief valve, wherein the warning system further comprises control circuitry connected to the electric conduit, the control circuitry comprising processing circuitry configured to control the warning system, wherein the control circuitry is configured to be connected to a power source for powering the control circuitry independently from the battery device, wherein the processing circuitry is configured to obtain sensor data associated with the voltage in the electric conduit from one or more sensor(s) configured to monitor the electric conduit and wherein the processing circuitry is further configured to control the indicating device based on the sensor data, wherein the processing circuitry is configured to perform self-diagnostic tests of the warning system, wherein the electromechanical switch is configured to be selectively connected to an energy storage device such that the electromechanical switch in an inactive state is configured to disconnect the energy storage device from the electric conduit and in an activated state is configured to connect the energy storage device to the electric conduit, and wherein the energy storage device and the power source are configured to operate at different voltages.

20. A vehicle comprising a warning system of claim 1.
